(19) United States
(12) Patent Application Publication
(10) Pub. No.: US 2011/0295605 A1
(43) Pub. Date: Dec. 1, 2011

(54) SPEECH RECOGNITION SYSTEM AND METHOD WITH ADJUSTABLE MEMORY USAGE

(75) Inventor: Shiuan-Sung LIN, Pingtung (TW)

(73) Assignee: INDUSTRIAL TECHNOLOGY RESEARCH INSTITUTE, Hsinchu (TW)

(21) Appl. No.: 12/979,739

(22) Filed: Dec. 28, 2010

(30) Foreign Application Priority Data
May 28, 2010 (TW) 099117320

(51) Int. Cl. G10L 15/08

(52) U.S. Cl. 704/251; 704/E15.014

(57) ABSTRACT

This speech recognition system provides a function that is capable of adjusting memory usage according to the different target resources. It extracts a sequence of feature vectors from input speech signal. A module for constructing search space reads a text file and generates a word-level search space in an off-line phase. After removing redundancy, the word-level search space is expanded to a phone-level one and is represented by a tree-structure. This may be performed by combining the information from dictionary which gives the mapping from a word to its phonetic sequence(s). In the online phase, a decoder traverses the search space, takes the dictionary and at least one acoustic model as input, computes score of feature vectors and outputs decoding result.

### TECHNICAL FIELD

The disclosure generally relates to an a speech recognition system and method with adjustable memory usage

### BACKGROUND

In speech recognition technology, the applications are categorized according to the vocabulary size into small vocabulary (e.g., <100 words), middle-size vocabulary (e.g., 100-1000 terms), large vocabulary (e.g., 1001-10000 words) and extra-large vocabulary (>10000 words), and may also be categorized according to utterance as isolated word pronunciation (decouple between words), single word continuous speech (further divided into isolated word, and word segmentation), and whole sentence continuous speech. Among the categories, the category of consisting of extra-large vocabulary and continuous speech is the most complicated technology in the speech recognition column. For example, a dictation machine is an application of such technology. This technology also indicates the large usage of memory space and computation time resource. Therefore, a server-based device is required for the operation.

Even with the advance of the technology, most client-end machines, such as, smart phones, GPS, other mobile devices, are still lack of the computational resource of the server-based device. In addition, the client-end machines are usually not targeting at speech recognition, and are usually operating in multi-tasking mode for various applications. This further restricts the resources allocated to individual application. Thus, speech recognition is not widely applied to these client-end machines.

Some documented technologies use client-server architecture to optimize the resource allocation, such as, the speech recognition technology based on dynamic access search network.

An exemplary continuous speech decoder, as shown in FIG. 1, uses a three-layer network, i.e., word network layer 106, phonetic network layer 104 and dynamic programming layer 102. Also, during the recognition phase, the decoder performs vocabulary data concatenating and memory space pruning. In off-line phase, the continuous speech decoder uses the mutually-independent three layers first construct search space and then in online execution phase, the information of the three layers is dynamically accessed to reduce the memory usage.

Currently, a speech recognition technology able to remove redundancy and fully expand the context-dependent search space, or a speech recognition device and method for large vocabulary is to combine vocabulary and grammar in a finite-state machine (FSM) as recognition search network to eliminate the grammar parsing step and obtain the grammar contents from the recognition results directly.

In addition, an exemplary intelligent method for adjusting catalog structure for dynamic speech may be shown in the flowchart of FIG. 2, starts with a speech system extracting an original speech catalog structure and using an optimization adjusting mechanism to adjust the original speech catalog structure to obtain an adjusted speech catalog structure for replacing the original speech catalog structure. This method may reorganize the speech catalog structure of the speech functional system according to the user-setting so that the user may effectively receive better service.

In the large vocabulary continuous speech recognition, as the number of included word vocabulary increases, the usage of computation and memory also increases. In general, FSM optimization are used for improvement, such as, merge repeated paths, transform text into phone sequence according to dictionary (usually with a corresponding mapping phonetic model), and then re-merge repeated paths, and so on. FIG. 3 shows an exemplary schematic view of two basic phases in a general large vocabulary continuous speech recognition technology. As shown in FIG. 3, the two basic phases are off-line construction phase 310 and online decoding phase 320. In off-line construction phase 310, word-level search space 312 required by recognition is constructed with language model, grammar and dictionary. In online decoding phase 320, a decoder 328, search space 312, acoustic model 322 and extracted feature vectors of input speech 324 are used to execute continuous speech recognition to generate decoding result 326.

### SUMMARY

The disclosed exemplary embodiments may provide a speech recognition system and method with adjustable memory usage.

In an exemplary embodiment, the disclosure relates to a speech recognition system with adjustable memory usage. The system comprises a feature extracting module, a search space construction module and a decoder. The feature extraction module extracts a plurality of feature vectors from a series of input speech signals. The search space construction module generates a word-level search space from read-in text, and after removing redundancy from the word-level search space, partially expands the redundancy-removed word-level search space to a tree-structure search space. The decoder combines at least a dictionary and at least an acoustic model, according to the linkage relation of the tree-structure in the search space and the comparison of the plurality of feature vectors, and outputs a decoding result.

In another exemplary embodiment, the disclosed relates to a speech recognition method with adjustable memory usage, applicable to at least a language system. The method comprises: extracting a plurality of feature vectors from a series of input speech signals; in an off-line phase, constructing a word-level search space from read-in text by employing a search space construction module, and after removing redundancy from the word-level search space, partially expanding the redundancy-removed word-level search space to a tree-structure search space through a mapping relation between word and phones provided by a dictionary; and in an online phase, combining at least dictionary and at least an acoustic model via a decoder, then according to a linkage relation of the search space tree-structure, outputting a decoding result after comparison with the plurality of feature vectors.

The foregoing and other o features, aspects and advantages of the disclosure will become better understood from a careful reading of a detailed description provided herein below with appropriate reference to the accompanying drawings.

### BRIEF DESCRIPTION OF THE DRAWINGS

FIG. 1 shows an exemplary schematic view of the operation of a continuous speech decoder.

FIG. 2 shows an exemplary flowchart illustrating an intelligent method for adjusting catalog structure for dynamic speech.

FIG. 3 shows an exemplary schematic view of the two basic phases in a large vocabulary continuous speech recognition technology.

FIG. 4 shows an exemplary schematic view of a speech recognition system with adjustable memory usage, consistent with certain disclosed embodiments.

FIG. 5A shows an exemplary schematic view illustrating the linkage relation of the word-level search space, consistent with certain disclosed embodiments.

FIG. 5B shows an exemplary a schematic view of the word-level search space, consistent with certain disclosed embodiments.

FIGS. 6A-6D show an exemplary schematic view of generating a word-level search space from read-in text, consistent with certain disclosed embodiments.

FIG. 7 shows an exemplary schematic view of expanding a word-level search space to a phone-level search space, consistent with certain disclosed embodiments.

FIGS. 8A-8B show an exemplary schematic view of removing redundancy during expanding from word-level to phone-level, consistent with certain disclosed embodiments.

FIG. 9 shows an exemplary flowchart of constructing a search space from read-in text, consistent with certain disclosed embodiments.

FIG. 10 shows an exemplary flowchart of partial expansion from word-level search space to phone-level search space, consistent with certain disclosed embodiments.

FIG. 11A shows an exemplary schematic view of the states of a word-level search space in the descending order of the number of repetitions, consistent with certain disclosed embodiments.

FIG. 11B shows an exemplary schematic view of a partial expansion to describe the search space having partially expanded phone-level search space and some part pointing to positions in dictionary, consistent with certain disclosed embodiments.

FIGS. 11A-12D show a working exemplar of flowchart of FIG. 9, consistent with certain disclosed embodiments.

FIG. 13 shows an exemplary schematic view illustrating the situation wherein partially expanded phone-level search space able to handle pronunciation variants of a word, consistent with certain disclosed embodiments.

FIG. 14 shows an exemplary schematic view illustrating the search space size depends on different expansion ratio, consistent with certain disclosed embodiments.

FIGS. 15A-15C show exemplary schematic views of the application of the disclosed exemplary embodiments on to short words in English language system.

FIGS. 16A-16C show exemplary schematic views of the application of the disclosed exemplary embodiments on to long words in English language system.

FIG. 17 shows an exemplary flowchart illustrating how a decoder performs recognition according to a linkage relation constructed by the search space, consistent with certain disclosed embodiments.

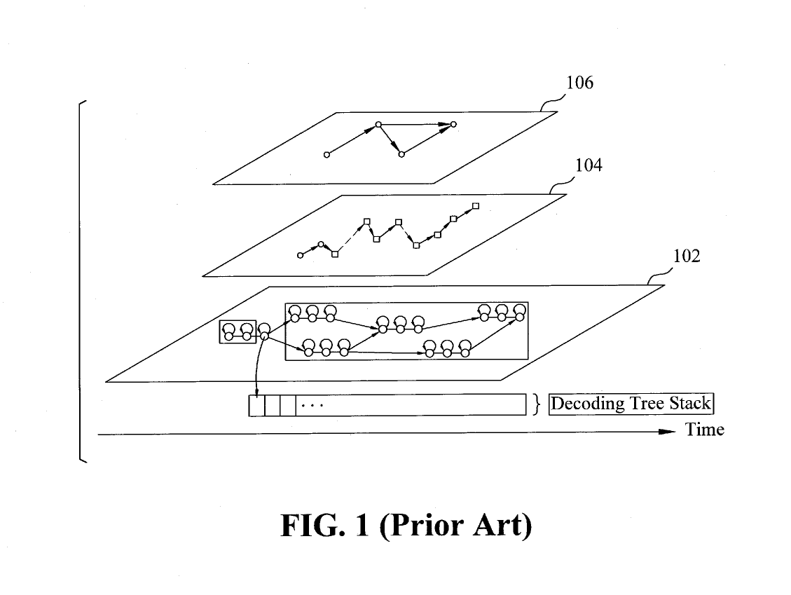

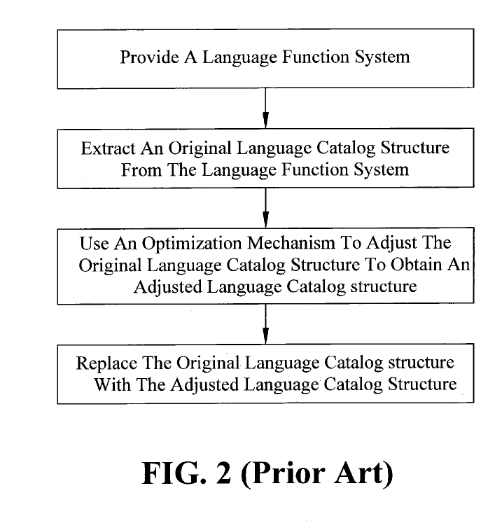

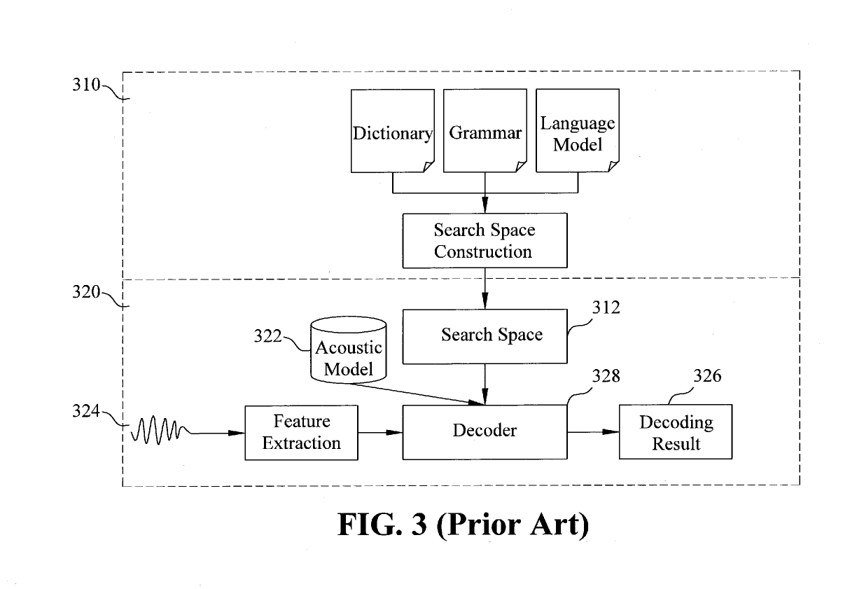

### DETAILED DESCRIPTION OF THE EXEMPLARY EMBODIMENTS

The exemplary embodiments of the disclosure construct a data structure applicable to large vocabulary continuous speech recognition, and construct a memory usage adjusting mechanism depending on the resources available on different devices, so that speech recognition application may be adjusted and executed optimally according to the device resource limitation.

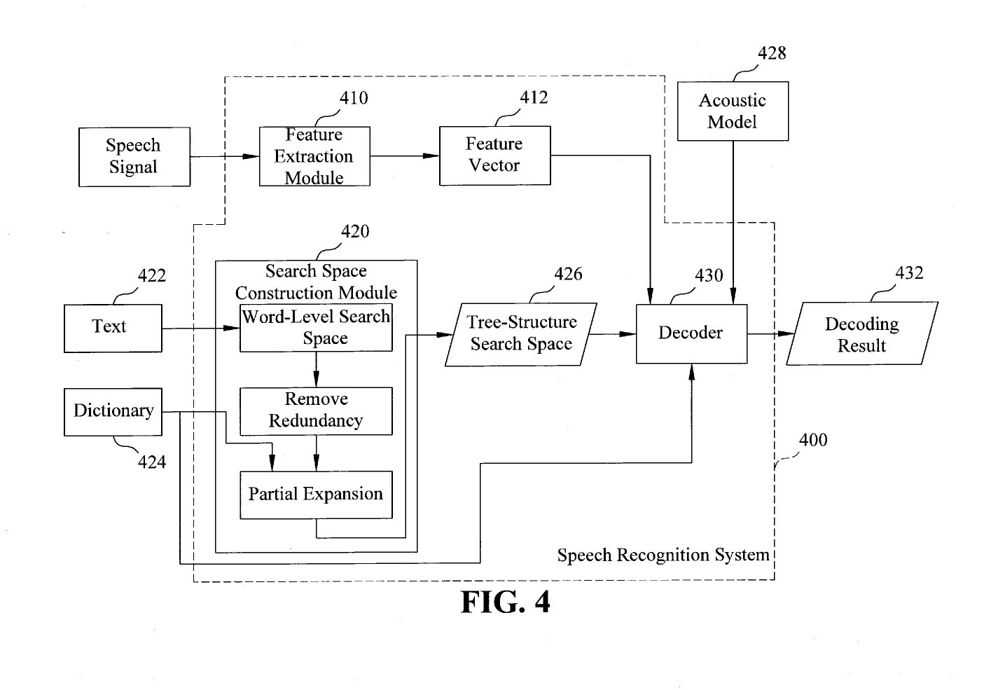

FIG. 4 shows an exemplary schematic view of a speech recognition system with adjustable memory usage, consistent with certain disclosed embodiments. In FIG. 4, speech recognition system 400 comprises a feature extracting module 410, a search space construction module 420 and a decoder 430. The operation of speech recognition system 400 is described as follows. Feature extraction module 410 extracts a plurality of feature vectors 412 from a series of input speech signals. After extraction, a plurality of frames is obtained. The number of frames depends on the recording length of the input speech signals. These frames may be expressed as vectors. In an offline phase, search space construction module 420 generates a word-level search space from read-in text 422, and after removing redundancy from the word-level search space, through a mapping relation between the word and the phones provided by at least a dictionary 424, search space construction module 420 partially expands the redundancy-removed word-level search space to a tree-structure search space 426. In an online phase, decoder 430 combines dictionary 424 and at least an acoustic model 428, according to the tree-structure linkage relation of search space 426, and outputs a decoding result 432 after the comparison with the plurality of feature vectors 412.

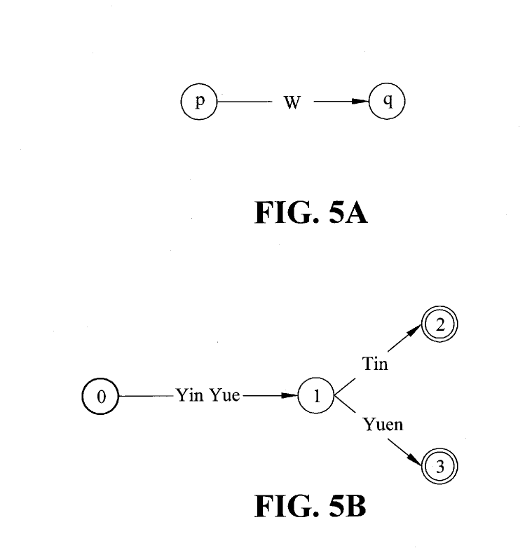

In offline phase, search space construction module 420 may construct word-level search space via language model or grammar. Word-level search space may use a FSM to represent the linkage relation between words. The linkage relation of word-level search space may be shown as the example of FIG. 5A, where p, q are states. A directional transition from state p to state q may be expressed as p->q, and information W carried by the directional transition is word. FIG. 5B shows an exemplary schematic view of a word-level search space, consistent with certain disclosed embodiments, where 0 is the starting point and 2 and 3 are terminating points. In the example of FIG. 5B, word-level search space includes four states, labeled as 0, 1, 2, 3, respectively. Path 0->1->2 carries the information “Yin Yue Tin”, i.e. “Music Hall” in English, while path 0->1->3 carries the information “Yin Yue Yuen”, i.e. “Music Dome” in English.

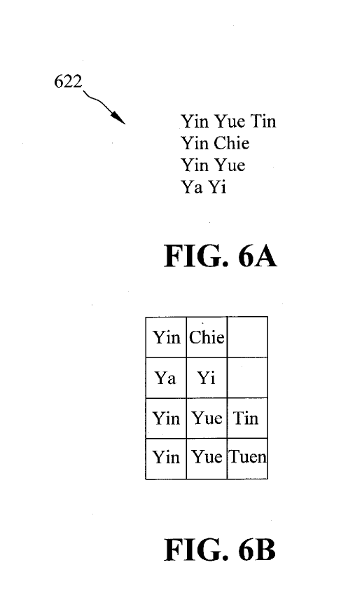

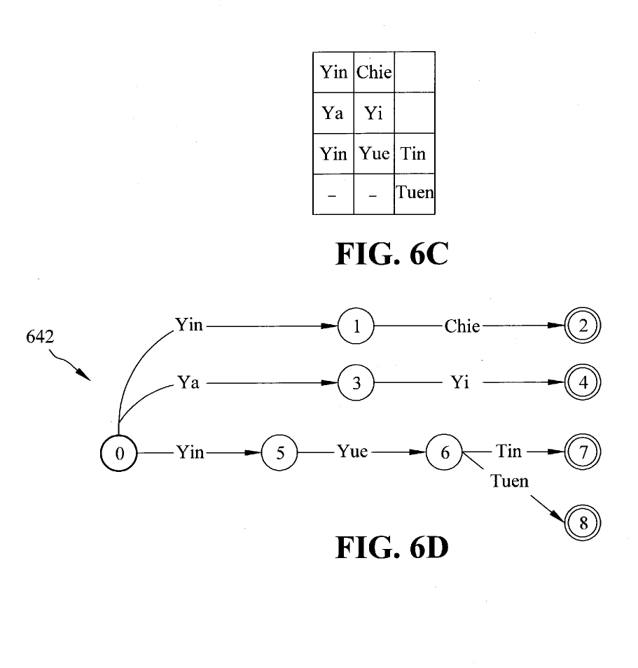

For the read-in text, the disclosed exemplary embodiments will check all the words transited from the same state and remove the redundancy while constructing the linkage relation between words. FIGS. 6A-6D use a text as exemplar to describe how a word-level search space is constructed for a read-in text, consistent with certain disclosed embodiments. FIG. 6A shows an exemplary read-in text 622. Text 622 is stored to a matrix sequentially, as shown in FIG. 6B. Then, redundancy is removed. Accordingly, the redundancy information “Yin-Yue”, i.e. Music in English, in the first and second columns of row 4 with same information of row 3 are removed, the result is as shown in FIG. 6C. The result in FIG. 6C is labeled starting from the first column of row 1, such as starting with 0, and a direction transition is used to establish a linkage relation between words of text 622, until all the words are labeled. FIG. 6D shows the final constructed word-level search space 642. Redundancy-removed search space 642 maintains a tree-structure. This tree-structure will help in preserving the top decoded results after decoding.

Because the read-in computational data is acoustic model during decoding, a large amount of time will be spent to find the words and their corresponding acoustic model in real time if the word-level search space is used as the search space in decoding. Also, if there are multiple words mapped to the same acoustic model, i.e., homonym, for example “Yin”, i.e. “sound” in English, and “Yin”, i.e. “earnest” in English, the homonym will impose a large burden on the time-sensitive and space-sensitive speech recognition system. In general, the word-level search space is transformed into a phone-level search space to improve the decoding efficiency.

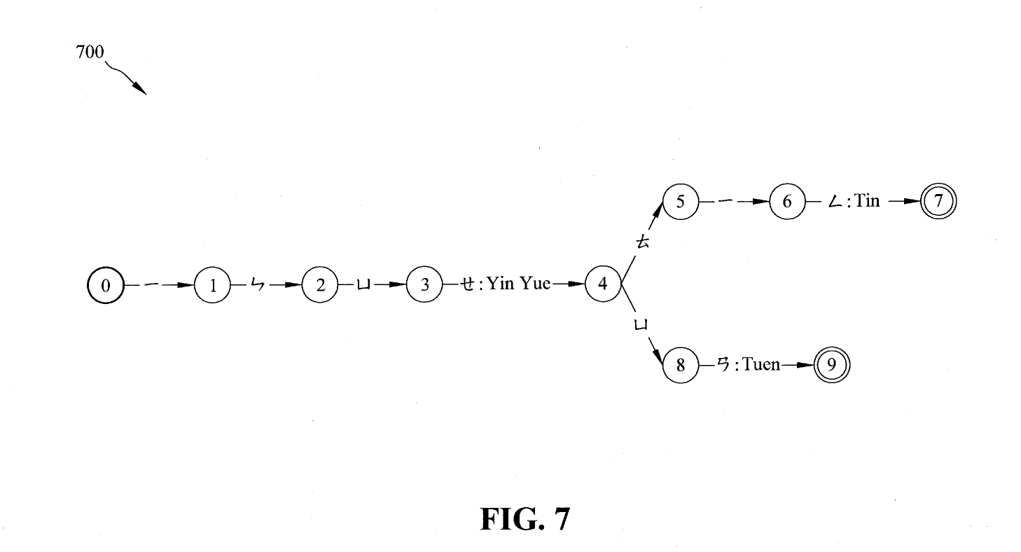

After the word-level search-space is constructed, search space construction module 420 may use the mapping relation between word and phones provided by dictionary to transform the word-level search space to the phone-level. Take FIG. 5A as example, word-level search space may be constructed through language model or grammar. FIG. 7 shows an exemplary schematic view of expanding word-level search space of FIG. 5A into a phone-level search space. In the exemplar of FIG. 7, the following word-phonetic mapping relation is provided by a dictionary: The word “Yin-Yue” corresponds to “Y-IN-YU-E”, the word “Tin” corresponds to “T-I-N”, and the word “Yuen” corresponds to “YU-EN”. Then, the search space is expanded according to the mapping relation into phonetic search space 700.

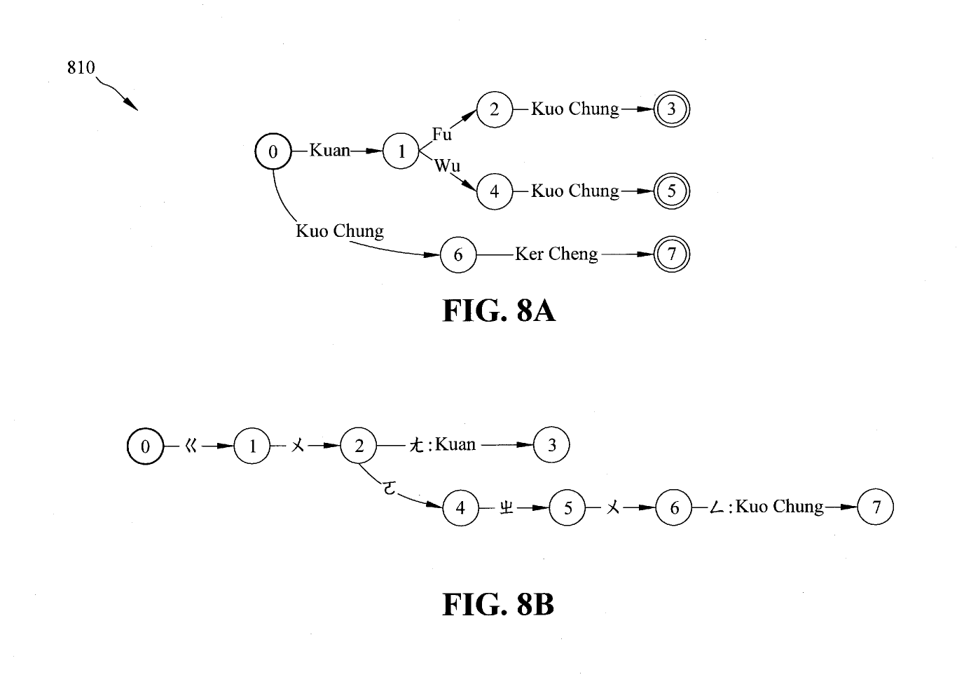

With the dictionary, word-level search space may be transformed into a phone-level search space. However, the redundancy problem also occurs in the transformation to phone-level. For example, in the word-level search space 810 of FIG. 8A, the two transitions from state 0 carry respectively the words “Kuan”, i.e. “light” in English, and “Kuo-Chung”, i.e. “Junior High” in English, corresponding to phones “KU-AN” and “KU-O-CH-U-NG”, respectively. Both include a phone of “KU”. When constructing phonetic search space, the disclosed exemplary embodiments also exam each state and remove the redundancy to reduce the unnecessary computation and memory storage caused by the redundancy. Accordingly, the two transitions from state 0 carry “Kuan” and “Kuo-Chung”, when expanded to a phone-level, the redundant “KU” will be removed. FIG. 8B shows an exemplary schematic view of the expanded phone-level with two transitions carrying “Kuan” and “Kuo-Chung” from state 0.

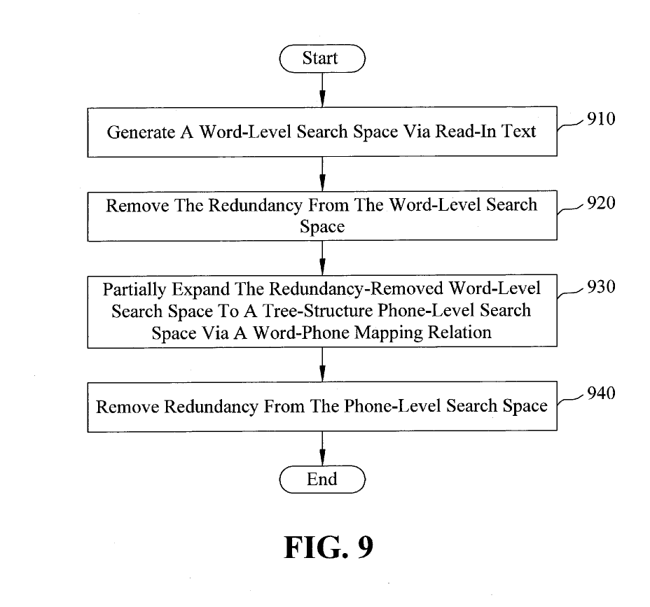

After all the words are expanded to the phone-level, a plurality of states and transitions will be generated. The more the number of states and transitions are generated, the more the memory space is required. During decoding, because the less use of dictionary to find word-phonetic mapping relation, the faster the search or computation is. In the word-level transforming to phone-level process of the disclosed exemplary embodiments, not only the partial expansion design conforms to the memory restriction, such as, less than a threshold, but also concerns the search and computation speed. The partial expansion design includes phone-level search space having a tree-structure, pointing word-level redundant words to the same position in dictionary, and removing redundant information in phone-level search space. FIG. 9 shows an exemplary flowchart of constructing a search space via read-in text, consistent with certain disclosed embodiments.

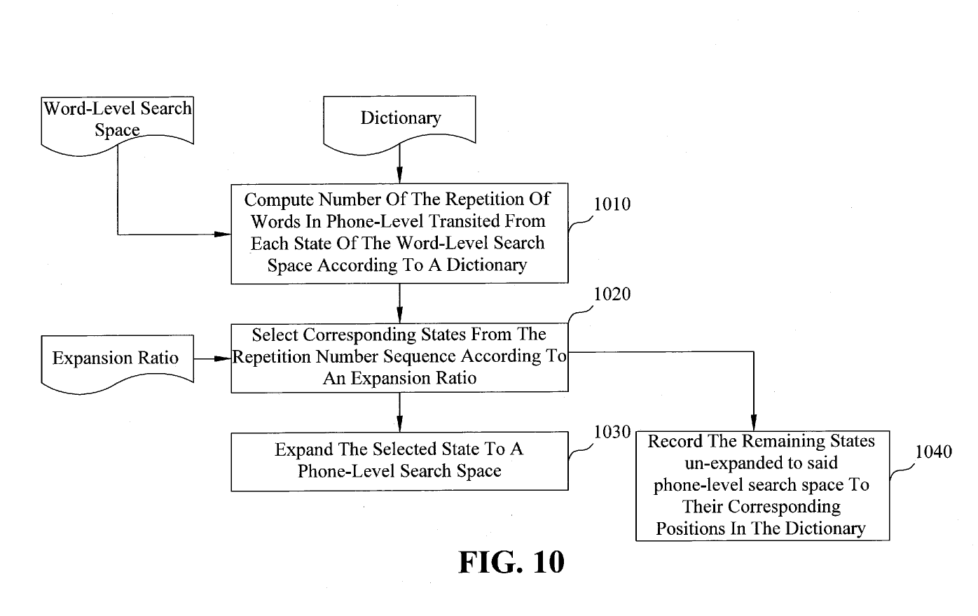

Referring to FIG. 9, first, a word-level search space is generated via read-in text (step 910), and the redundancy is removed from the word-level search space (step 920). Then, the redundancy-removed word-level search space is partially expanded to a tree-structure phone-level search space via a word-phonetic mapping relation (step 930). And, redundancy is further removed from the phone-level search space (step 940). FIG. 10 further describes the detailed flow for partial expansion from word-level to phone-level, consistent with certain disclosed embodiments.

After redundancy-removed word-level search space is realized with a FSM, in the exemplary flow of FIG. 10, the number of the repetition of words in phone-level transited from each state of the word-level search space is computed according to a dictionary, as shown in step 1010. Then, corresponding states are selected from the sequence of repetition numbers according to an expansion ratio, as shown in step 1020. The selected states are expanded to a phone-level search space, as shown in step 1030. The remaining states un-expanded to said phone-level search space are recorded to their corresponding positions in the dictionary, as shown in Step 1040. The expanded phone-level search space and the recorded corresponding positions in the dictionary may be generated in a single file.

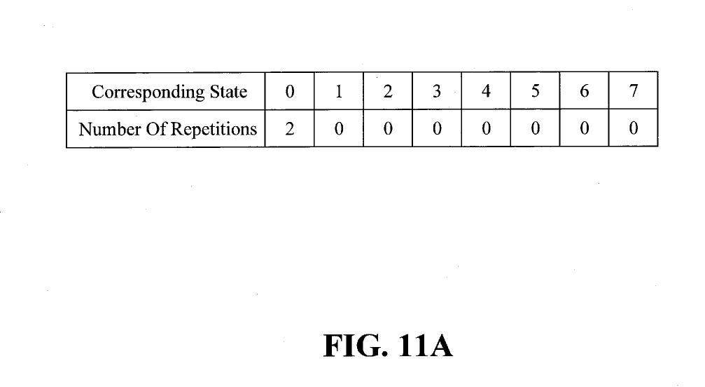

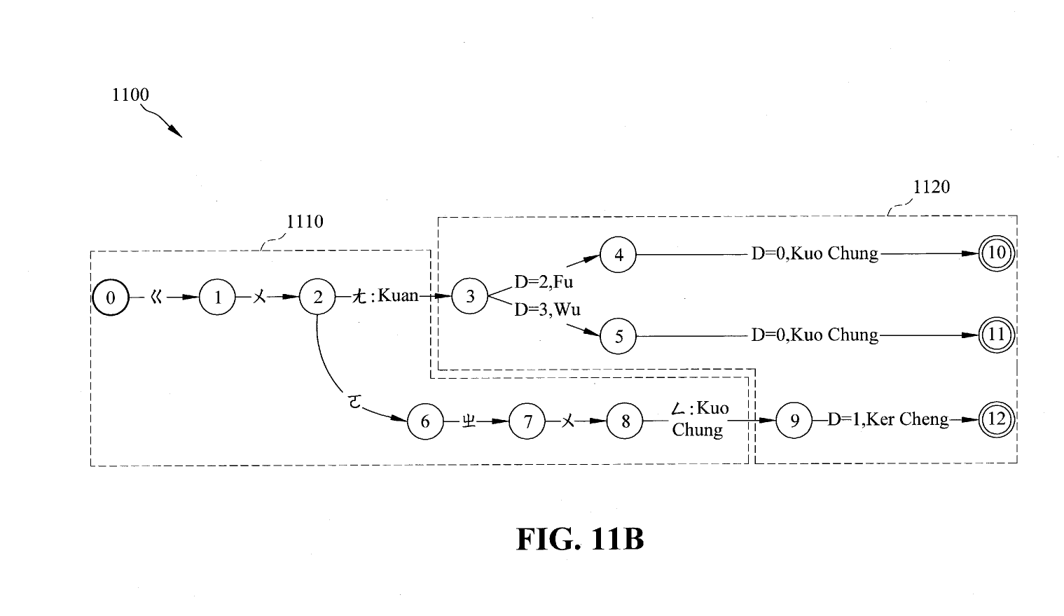

Take word-level search space 810 of FIG. 8A as an example. Word-level search space 810 includes 8 states, labeled as 0-7. Among, states 0-7, only state 0 has repetition twice, while the other states have no repetition. The ordered sequence of the repetition times is shown in FIG. 11A. Assume that only state 0 is selected for expansion, while the remaining states stay un-expanded. After step 1030, the generated search space 1100 is shown in FIG. 11B. Search space 1100 includes a partially expanded phone-level search space 1110 and dictionary positions 1120 corresponding to unexpanded states, where D=# indicates the position of a word in the dictionary, such as, “D=2, Fu” indicating the word “Fu”, i.e. “recover” in English, is at position 2 in the dictionary. The corresponding pronunciation and acoustic model may be found via the position 2.

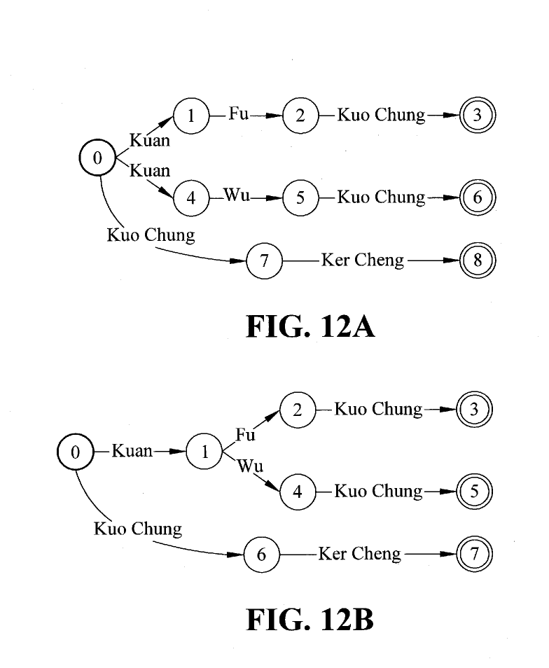

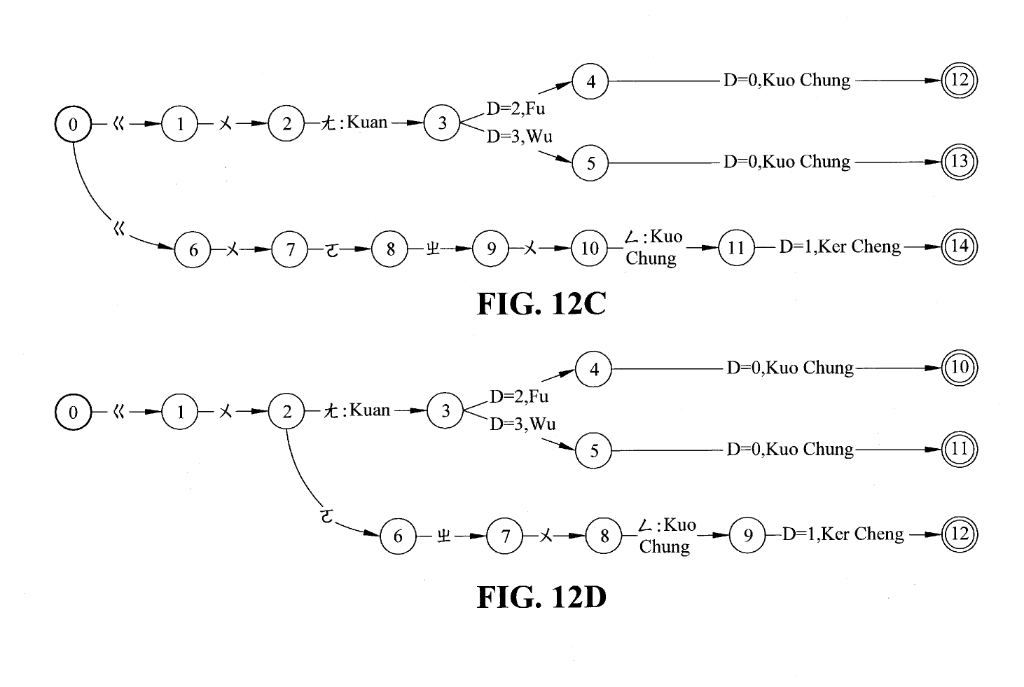

Accordingly, FIGS. 12A-12D use a working example to describe an exemplary flowchart of FIG. 9 using partial expansion to construct the search space, where read-in text is as follows:

“Kuan-Fu-Kuo-Chung” i.e. “Kuan-Fu Junior High” in English

“Kuan-Wu-Kuo-Chung i.e. “Kuan-Wu Junior High” in English

“Kuo-Chung Ker-Cheng i.e. “Junior High Curriculum” in English

After step 910, the word-level search space generated for the above read-in text is shown in FIG. 12A. After step 920, the redundancy-removed search space, i.e., the two transitions from state 0 carrying the word “Kuan”, is as shown in FIG. 12B. After step 930, FIG. 12B is partially expanded to a tree-structure phone-level search space, as shown in FIG. 12C. After step 940, the redundancy-removed phone-level search space, i.e., removing redundancy “KU”, is as shown in FIG. 12D.

In the partial expansion design, the state selected for expansion may be determined by the following exemplary equation.

$$arg {max}_{v} f ( v ) := \{ v \vert ( {\sum }_{i = 1}^{{v}_{s}} r ( {v}_{i} ) + {\sum }_{i = {v}_{s + 1}}^{{v}_{N}} {r}^{′} ( {v}_{i} ) ) \times m \leq M \}$$

where N is total number of states, {v₁, v₂, . . . , vₛ} are selected states based on an assigned ratio, the unselected states are {vₛ₊₁, vₛ₊₂, . . . v_{N}}, r(vᵢ) is the transition number of a selected state after transforming words into phone sequence and removing redundancy, while r′(vᵢ) represents the transition number of an non-expanded states, m is the memory size used by each transition, and M is the maximum memory limit of system or applications. Take search space 1110 of FIG. 11B as an example, r(v₀)=1, r′(v₃)=2, r′(v₄)=r′(v₅)=r′(v₉)=1. For the non-expanded states, their labels are transformed into the positions in the dictionary, thus the number of transitions associated with these states does not increase. The position in dictionary is used to find the corresponding pronunciation and acoustic models.

In other words, the above equation is related to a plurality of parameters. The parameters are selected from the number of states of FSM, selected states according to an expansion ratio, un-selected states, the number of transitions of selected expanded states after removing redundancy, the number of transitions of unexpanded states, and the memory size used by every transition.

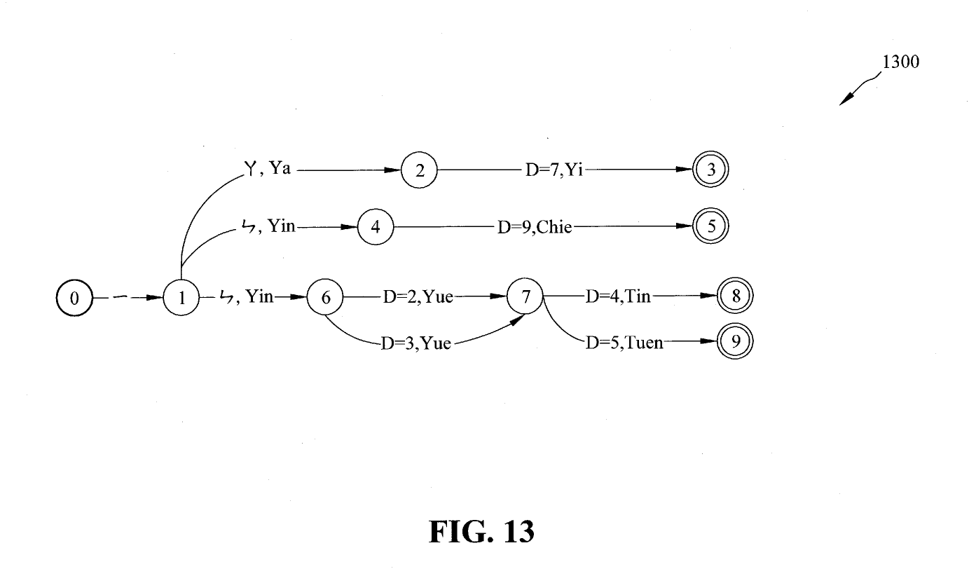

The expanded result may also process the situation where a word has multiple pronunciations. For example, in partial expansion phone-level search space 1300 of FIG. 13, word of state 6 “Yue” may also be pronounced as “Ler”, i.e. happy in English, corresponding to two positions in the dictionary respectively, i.e., D=2, D=3. This only slightly increases the search space size. If the text is segmented into individual words in advanced, the search space may further be reduced.

Furthermore, when another different expansion ratio is used, the search space size will also vary. Take the 1000 test sentences of a telephone call-in system as an example, some of the contents are:

“Jer-Li-Bai-San” “Yaw-Ching-Jia”

“Wor” “Min-Tien-Juaw-Sang” “Yaw-Ching” “Shiu-Jia “Ban-Tien”

“Wor-Shian-Chua” “Wor” “Hai-You” “Gi-Tien-Jia”

The corresponding English meaning for the above text is as follows.

“would like to take this Wednesday off”

“I would like to take half day off tomorrow morning”

“I would like to know how many days of leaves that I still have”

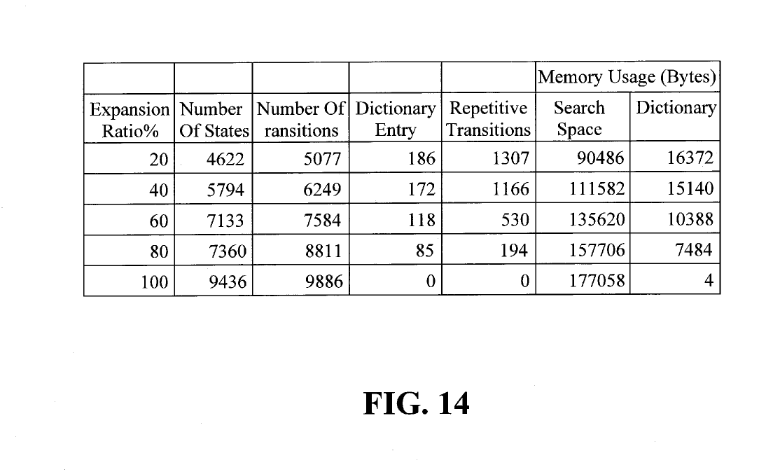

In the above text, each sentence is composed of different words of various lengths. By gradually increasing the partial expansion ration, the word-level search space is transformed into phone-level search space. The included state, number of transitions and generated dictionary entries are as shown in FIG. 14.

As sown in the example of FIG. 14, when the expansion ratio is 20%, search space uses 90486 bytes of memory. When fully expanded (100%), search space uses 177058 bytes of memory. Therefore, when expansion ratio=20%, 186 dictionary entries (16372 bytes) are sufficient to reduce the search space up to 40% in comparison with full expansion. Therefore, for devices with limited resources, the partial expansion design of the disclosed exemplary embodiments may effectively reduce the demands on the memory usage. The adjustable expansion ratio also allows wide applications. For different resource limitation and applications, such as, PC, client or server device, or mobile device, the optimal balance between time and space may be achieved.

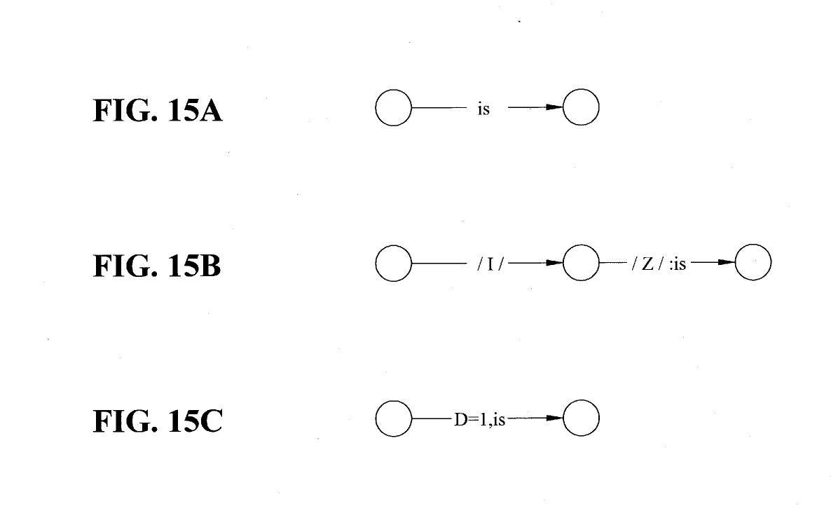

The disclosed exemplary embodiments may also be applied to other languages or multi-lingual systems, as long as the foreign word-phonetic mapping relation is added to dictionary. FIGS. 15A-15C shows an application of the disclosed exemplary embodiments to short words in English language system. Short word “is” may also be represented with a transition from one state to another state carrying information “is”, as shown in FIG. 15A. Via the English word-phonetic mapping relation, i.e., “is” mapped to “I” and “Z”, the word-level expansion to phone-level is shown in FIG. 15B. Word “is” may also point to a specific position in dictionary, such as, D=1, as shown in FIG. 15C.

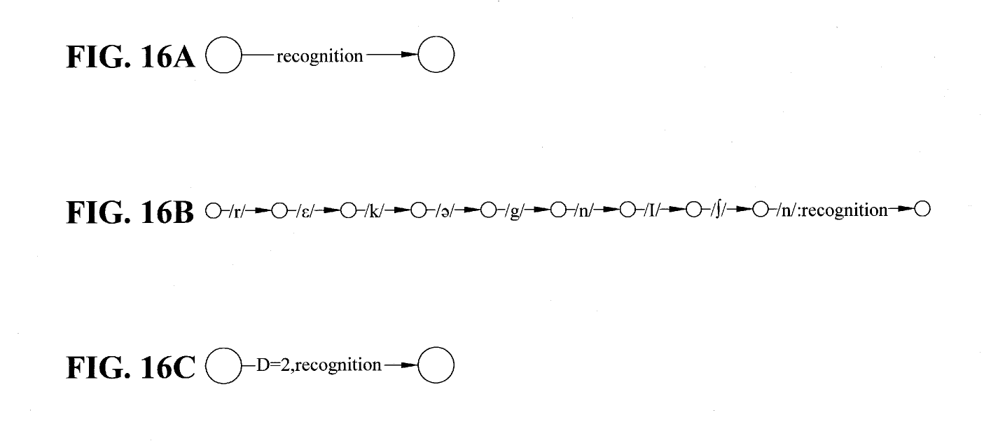

Similarly, FIGS. 16A-16C shows the disclosed exemplary embodiments applied to long word “recognition” in English language system. Long word “recognition” may also be represented with a transition from one state to another state carrying information “recognition”, as shown in FIG. 16A. Via the English word-phonetic mapping relation, the word “recognition” is expanded to phone-level, as shown in FIG. 16B. Word “recognition” may also point to a specific position in dictionary, such as, D=2, as shown in FIG. 16C. As shown in FIG. 16B, the effect on reducing memory demands is even more prominent for long words.

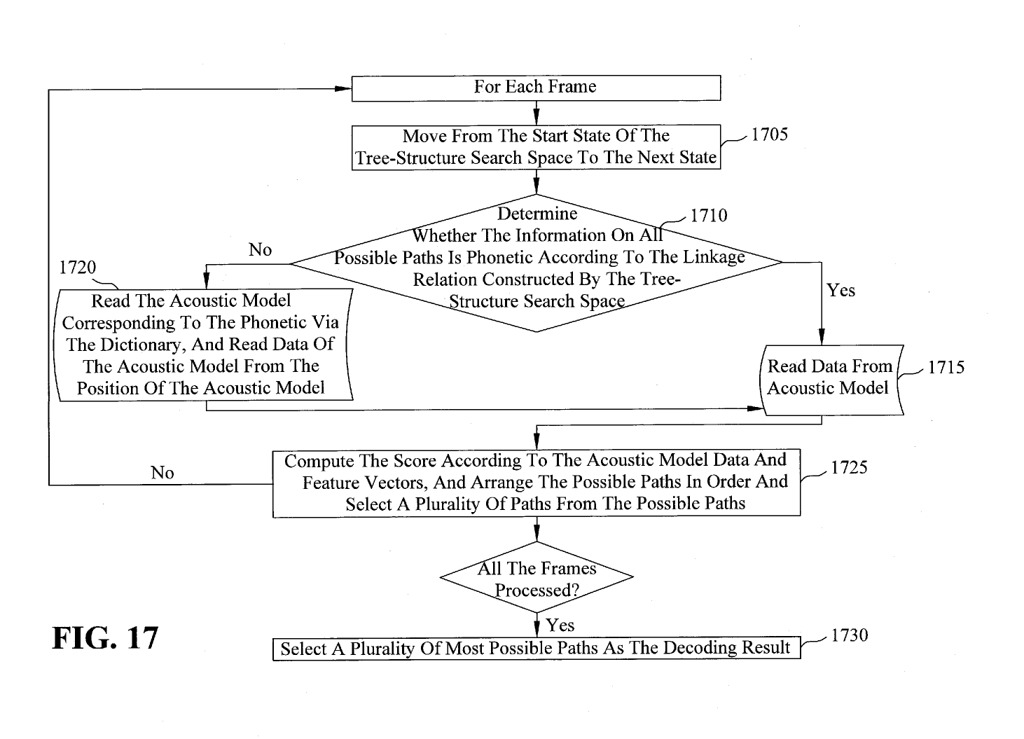

For the same word, regardless of which entry, the access position in the dictionary is always the same. Hence, regardless of the phone-level expansion size, one copy of access space for word-phonetic mapping relation is enough. In the disclosed exemplary embodiment, the trade-off is between the search for word-phonetic mapping relation and the saved memory space. For word-level transformation to phone-level phase in the offline, the information on the path of un-expanded states points to a specific position in the dictionary. After the search space is constructed, during the decoding phase in the online, for each frame, a little time is spent to determine whether the information on all the possible paths is phonetic. If not, the dictionary is used to read the corresponding acoustic model of the phonetic. FIG. 17 shows an exemplary flowchart of the decoding process following the linkage relation constructed with the search space, consistent with certain disclosed embodiments.

As aforementioned, a plurality of frames may be obtained after extracting a plurality of feature vectors from the input speech signals. Referring to FIG. 17, for each frame, the operating flow may include steps 1705—step 1730 as following: moving from the start state, such as, labeled 0, of the tree-structure search space to the next state (step 1705); determining whether the information on all possible paths is phonetic according to the linkage relation constructed by tree-structure search space (step 1710); if so, reading data from acoustic model (step 1715); otherwise, reading the acoustic model corresponding to the phonetic via the dictionary, and reading data of the acoustic model from the position of acoustic model (step 1720). The acoustic model data may include, such as, corresponding average, variance, and so on. The mapping relation from phonetic of the dictionary to acoustic model is accomplished in the offline phase.

According to the acoustic model data and feature vectors, it may compute the score and arrange the possible paths in order, such as, by score, and select a plurality of paths from the possible paths, as shown in step 1725. The above steps 1710, 1715, 1720, and 1725 are repeated until all the frames are processed. Then, a plurality of most possible paths, such as, paths with highest scores, is selected as the decoding result, as shown in step 1730.

In summary, the disclosed exemplary embodiments may provide a speech recognition system and method with adjustable memory usage, which may be applicable to different devices or systems with different resource limitation to obtain the optimal execution efficiency and speech recognition. In an offline phase, a search space for targeting at limited resource is constructed. In an online phase, the decoder combines the search space, dictionary and acoustic model to compare with the feature vectors extracted from input speech signals to find at least a decoding result. The effect of the disclosed exemplary embodiments in achieving the balance between time and space optimization is more prominent in large vocabulary continuous speech system, and is not restricted to any specific hardware platforms.

Although the disclosure has been described with reference to the exemplary embodiments, it will be understood that the disclosure is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A speech recognition system with adjustable memory usage, comprising:
a feature extracting module, for extracting a plurality of feature vectors from a plurality input speech signals;
a search space construction module, for generating a word-level search space from read-in text, and after removing redundancy from said word-level search space, partially expanding said redundancy-removed word-level search space to a tree-structure search space; and
a decoder, for combining at least a dictionary and at least an acoustic model, comparing with said plurality of feature vectors according to linkage relation of said search space tree-structure and outputting a decoding result.

2. The system as claimed in claim 1, wherein said word-level search space uses a finite state machine (FSM) to represent said linkage relation between words, and information carried by a transitions from one state to another state is word.

3. The system as claimed in claim 1, wherein said search space construction module partially expands said redundancy-removed word-level search space to said tree-structure search space according to a memory usage restriction.

4. The system as claimed in claim 1, said system is not limited to operate on a single language system.

5. The system as claimed in claim 2, wherein said tree-structure search space further includes a phone-level search space having partially expanded states and at least a dictionary position corresponding to un-expanded states.

6. The system as claimed in claim 2, wherein if said phone-level search space has redundancy of repeated information, said search space construction module removes said redundancy from said phone-level search space.

7. The system as claimed in claim 1, wherein said decoder follows a plurality of possible paths based on said linkage relation constructed by said tree-structure search space and extracts several paths from said possible paths as said decoding result.

8. The system as claimed in claim 2, wherein said decoder in an online-phase, extracts at least a corresponding pronunciation and acoustic model from said at least a dictionary position corresponding to said un-expanded states.

9. The system as claimed in claim 1, wherein said search space construction module operates in an offline phase.

10. A speech recognition method with adjustable memory usage, applicable to at least a language system, said method comprising:
extracting a plurality of feature vectors from a plurality of input speech signals;
in an off-line phase, applying a search space construction module to construct a word-level search space from read-in text, and after removing redundancy from said word-level search space, partially expanding said redundancy-removed word-level search space to a tree-structure search space through a mapping relation between word and phonetics provided by a dictionary; and
in an online phase, combining said dictionary and at least an acoustic model via a decoder, according to linkage relation of said search space's tree-structure, comparing with said plurality of feature vectors, and outputting a decoding result.

11. The method as claimed in claim 10, wherein said generating the word-level search space further includes:
storing said read-in text into a matrix following an order;
starting from first column of first row of said matrix, comparing with previous rows and removing redundancy from said matrix; and
starting from first column of first row of said redundancy-removed matrix, labeling each word and using a directional transition to construct said linkage relation between words of said read-in text until finishing last column.

12. The method as claimed in claim 10, wherein said partially expanding the redundancy-removed word-level search space to said tree-structure search space further includes:
realizing said redundancy-removed word-level search space with a finite state machine (FSM);
expanding every state of said FSM according to a dictionary, computing number of repetitions of words in phone-level transited from every state;
selecting at least a corresponding state from a sequence of the repetition numbers according to an expansion ratio; and
expanding said at least a selected states to a phone-level search space, and recording at least a corresponding position in said dictionary for remaining states un-expanded to said phone-level search space.

13. The method as claimed in claim 12, wherein at least a corresponding pronunciation and at least an acoustic model are found from said at least a corresponding position in said dictionary.

14. The method as claimed in claim 10, wherein in offline phase, said redundancy-removed word-level search space is realized with a finite state machine (FSM), at least a corresponding state is selected from said FSM according to an expansion ratio for partially expanded to said tree-structure search space, and in said FSM, one state to another state is linked by directional transitions.

15. The method as claimed in claim 14, wherein said partially expanding said word-level search space to said tree-structure search space is to select said at least a corresponding state according to a system memory usage restriction.

16. The method as claimed in claim 14, wherein said selecting said at least a corresponding state is determined by a computation equation, said computation equation is related to a plurality of parameters, said plurality of parameters are selected from one group consisting of number of states of said FSM, selected states according to expansion ratio, unselected states, number of transitions of said selected expanded states after redundancy removed, number of transitions of unexpanded states, and memory usage of every transition.

17. The method as claimed in claim 14, further includes:
in said offline phase, pointing branch information of each of said unexpanded states to a specific dictionary position;
after constructing said tree-structure search space, in said online phase, after extracting a plurality of feature vectors from said input speech signals, obtaining a plurality of frames, and for each said frame, according to linkage relation constructed by said tree-structure search space; and
in said online phase, determining whether information on all possible paths of said tree-structure search space being a phonetic, if not, retrieving at least a corresponding pronunciation and at least an acoustic model from said dictionary position corresponding to said unexpanded state.
